(19) United States
(12) Patent Application Publication
(10) Pub. No.: US 2004/0114766 A1
(43) Pub. Date: Jun. 17, 2004

(54) Three-party authentication method and system for e-commerce transactions

(76) Inventors: Mark H. Hileman, Beavercreek, OH (US); Gary M. Cairns, Tipp City, OH (US)

Correspondence Address: Killworth, Gottman, Hagan & Schaeff, L.L.P., Suite 500, One Dayton Centre, Dayton, OH, 45402-2023, US

(21) Appl. No.: 10/228,017

(22) Filed: Aug. 26, 2002

(51) Int. Cl. H04L 9/00

(52) U.S. Cl. 380/278

(57) ABSTRACT

A method and system providing a secure system for purchasing goods or services from a gift provider over a network, such as the Internet, is disclosed. A gift giver purchases the goods or services for a gift recipient, wherein an encrypted key is generated for the transaction. Portions of the encrypted key are divided between the gift recipient and the gift giver, with a third party (e.g., the gift provider) holding the entire key and decryption tools. After delivery of a gift card to the gift recipient, communication between the gift giver and the gift recipient must be made to recombine the portions of the encrypted key. Upon submitting the complete key to the gift provider, the gift card is redeemed/activated giving it a monetary value or access to the goods and services.

### BACKGROUND OF THE INVENTION

The present invention is directed to electronic commerce (“e-commerce”) security, and more particularly to a method and system providing three-party authentication in a consumer gift-giving transaction over a computer network.

Today's consumers have the opportunity to make purchases over a public network, such as the Internet, from merchants. The typical model of making such purchases involves an electronic storefront/shopping cart system that allows a purchaser to simply order by selecting preferences and quantities of any electronically displayed product(s) and/or service(s). The electronic storefront is typically a web page being provided by a merchant's web server which is viewed from a web browser running on a remote communicative device to which the purchaser has access. By communicative device, it is meant any platform (Kiosk, PC, PDA, Web phone, Web TV, and the like) that may network (wireline or wireless) with the merchant's web server to receive/pass information.

Once the purchaser has completed selecting items from the electronic storefront page, the items are added to the electronic shopping cart which typically displays a price for each selected item and a total. When the purchaser has finished shopping, an order page is then presented. On the order page the purchaser verifies/modifies the order, fills in a shipping address, and enters billing/credit card information. If the purchaser desires to send the order as a gift, then the intended recipient's address would be used as the shipping address. Once the above information is provided, the purchaser submits the order by clicking on a checkout button.

It is to be appreciated that the above electronic transaction from at least the order page is typically conducted in a secured mode such that the information passed between the purchaser and the merchant's server is protected by cryptography. However, it is generally believed by some consumers that transactions, which are not conducted face-to-face, are prone to security and systematic problems. Many consumers uncomfortable with using e-commerce point to the fact that participants in electronic transactions are not in control of all portions of the system on which their transactions take place as multiple parties, entities, nodes, or servers comprise the system.

Making matters worse, public accounts of the exploits such as fraud, repudiation, interception, and attacks from computer hackers have eroded consumer confidence in making such purchases from a relatively unsecured public network. Additionally, although much of the security effort in e-commerce has been focused on authenticating both identities of the purchaser and merchant in the electronic transaction, there exists no satisfactory method of verifying a recipient's identity in granting access to the gift purchased by the gift giver.

In the above mentioned electronic gift-giving transaction model, there are at least three parties involved—the gift provider, the gift giver, and the gift recipient. In that model, usually the gift recipient is unaware that a transaction is taking place until receipt of the gift. Accordingly, the gift giver typically makes payments to the gift provider, who then in turn sends the item unexpectantly to the gift recipient. If such an electronic transaction should be intercepted by a computer hacker, minimum difficulty exists in which the interceptor could mimic the intended gift recipient and receive the gift without the gift provider, gift-giver, or the intended gift recipient knowing there is a problem.

Therefore, focused and magnified corporate desires exist for better methods of authenticating all parties involved in an electronic transaction to boost consumer confidences in making such electronic purchases. Additionally, there is a need for a secure electronic gift-giving transaction that facilitates consumer confidence that the intended recipient will receive the gift without fear of interception. Furthermore, there is a need for a more humanized electronic gift-giving process, as it is generally felt that the current process is too impersonal.

### SUMMARY OF THE INVENTION

The above-mention needs are met by the present invention providing a secure system for purchasing goods or services from a merchant over the Internet. A gift giver purchases the goods or services over the Internet for a gift recipient, wherein an encrypted key is generated for the transaction. In one embodiment, portions of the encrypted key are divided between the gift recipient and the gift giver, with a third party (e.g., the gift provider or merchant) holding the entire key and decryption tools. After physical delivery of the gift card, communication between the gift giver and the gift recipient must be made to recombine the portions of the encrypted key. Upon submitting the complete key to the gift provider, the gift card is redeemed/activated giving it a monetary value or access to the goods and services. This system creates a high level of confidence that the intended recipient has been reached by minimizing the risk of use of a valuable gift by an electronic pirate, or a mailbox thief.

In another embodiment, portions of the encrypted key are divided between the gift recipient and the gift provider, whereby the gift recipient's portion of the encrypted key is received by non-electronic means, such as a gift card mailing. The gift recipient activates/redeems the gift by transmitting the received portion of the encrypted key to the gift provider.

In accordance to a first aspect of the present invention, provided is a method of providing a secure gift-giving transaction via an electronic storefront of a merchant between a gift giver and a gift recipient. The method comprises receiving a gift order placed by the gift giver via the electronic storefront of the merchant, and generating at least first and second encrypted key portions. The method further includes transmitting gift order information containing the gift order and the second key portion to a gift provider, sending a gift card containing the second key portion to the gift recipient, receiving by the merchant from the gift recipient the second key portions, and combining the key portions to fulfill the gift order.

In accordance to another aspect of the present invention, a method of providing three-party authentication in a consumer gift-giving transaction between a gift giver and a gift recipient via a an electronic storefront of a merchant accessible over a computer network with a communicative device is provided. The method comprises placing a gift order electronically from the electronic storefront, receiving the gift order by a merchant server connected to the computer network, and generating first and second encrypted key portions upon the merchant sever receiving payment verification of the gift giver. The method further includes transmitting gift order information containing the second key portion to a gift provider connected to the computer network, sending a gift card containing the second key portion to the gift recipient, and receiving by the merchant server the second key portions to fulfill the gift order.

In accordance to still another aspect of the present invention, a system adapted to provide a secure gift-giving transaction between a gift giver and a gift recipient from a merchant server adapted to provide an electronic storefront and to receive a gift order placed by the gift giver via a communicative device over a network. The system comprises a key generating function adapted to generate at least first and second encrypted key portions in response to the merchant server receiving the gift order, and to provide one of the key portions to the gift recipient.

In accordance to still yet another aspect of the present invention, a system adapted to provide a secure gift-giving transaction between a gift giver and a gift recipient over a network via the gift giver using a communicative device is disclosed. The system comprises a merchant server adapted to provide an electronic storefront and to receive a gift order placed by the gift giver via the communicative device over the network. The system further includes a gift card manufacture server, wherein the merchant server is further adapted to generate at least first and second encrypted key portions, and to transmitting gift order information containing the gift order and the second key portion to the gift card manufacturer server.

These and other features and objects of the present invention will be apparent in light of the description of the invention embodied herein.

### BRIEF DESCRIPTION OF THE DRAWINGS

The following detailed description of the embodiments of the present invention can be best understood when read in conjunction with the following drawings, where like structure is indicated with like reference numerals and in which:

FIG. 1 is a schematic block diagram of an exemplary computing paradigm incorporating capabilities for a secure gift-giving transaction according to the present invention;

FIG. 2 is a flow chart diagram illustrating various secure gift-giving transaction embodiments according to the present invention;

FIG. 3 is a block diagram of a first system embodiment of the gift-giving transaction in accordance with the invention; and

FIG. 4 is a block diagram of a second system embodiment of the gift giving transaction in accordance with the invention.

### DESCRIPTION OF THE PREFERRED EMBODIMENTS

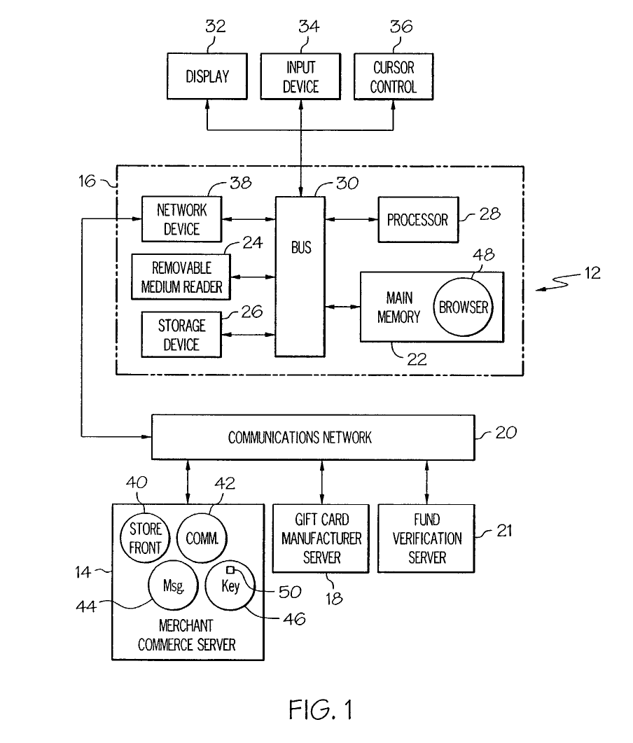

In the present invention, fraudulent access to goods and services purchased eletronically over an electronic commerce (“e-commerce”) system is made extremely difficult by the use of a mathematical key delivered at different times by different methods. FIG. 1 shows an exemplary computing paradigm for such an e-commerce system 12, which permits a consumer to electronically engage in a secure gift-giving transaction according to the present invention. The e-commerce system 12 comprises at least one merchant commerce server 14, at least one customer communicative device 16, a gift card manufacture server 18, and a communications network 20. Optionally, a fund verification server 21 may also be included which interacts with the merchant commerce server 14 to confirm that the consumer has provided sufficient monetary funds for the transaction.

The communications network 20 is preferably a packet-switch network, such as the global Internet, or any other means that promote communicative compatibility between the network nodes. Accordingly, the connections to the communications network 20 by the merchant's commerce server 14, the customer communicative device 16, the gift card manufacturer server 18, and other network nodes, such as the fund verification server 21 may be narrow, broadband, wireline, wireless, and a combination thereof. Additionally, if so desired, between the gift card manufacture server 18 and merchant commerce server 14 a virtual private network, i.e. the use of firewall servers, may be used.

The customer communicative device 16 is conventional, and generally is a personal computer comprising main memory 22 (random access memory (RAM) and read only memory (ROM)), a removable computer-medium reader 24, such as for compact disks, flash memories, magnetic tapes, a storage device 26, a processor 28, and a databus 30, which permits data to be communicated between such devices. The customer may interact with the customer communicative device 16 via a display 32, input device 34, such as a keyboard, and/or cursor control 36 such as a mouse, light pen, and/or stylus.

A network device 38, such as a modem or network interface card, is also provided to the customer communicative device 16 such that information may be passed between the merchant commerce server 14 and the customer communicative device 16 via the communications network 20. As with the customer communicative device 16, the servers 14, 18, and 21 in the e-commerce system 12 are also conventional, and since the servers essentially comprise the same components as the communicative device 16, for brevity, no further discussion on their internal components is provided.

One skilled in the art realizes that most computer and servers comprise essentially the same basic components, which are then programmed to function in a particular manner to accomplish as certain task and/or outcome. Accordingly, the discussion provided hereafter focuses on the functions that are provided by the communicative device 16 and servers 14, 18, and 21, which implement a secure electronic gift giving transaction over the communication network 20.

Additionally, in the discussion to follow, although the software functions which are principally relevant to the present invention are shown for purposes of illustration as existing or residing in main memory, persons skilled in the art to which the invention relates will understand that the application is illustrated in this manner because software is typically executed from such main memory and fetched into the main memory on an as-needed basis from other sources such as the mass memory or hard disk drive or from over the network. As such, persons will appreciate these software elements may or may not actually exist simultaneously or in their entirety in main memory.

Furthermore, a user can configure, initiate, and control the execution of the e-commerce transaction on the communicative device 16 in the conventional manner. Plus, in addition to the below-listed functions and routines described below that relate specifically to the present invention, the communicative device 16 and servers 14, 18, and 21 also include a conventional operating system to facilitate the execution of such programs and other functions typically performed by operating systems. A discussion on these functional features of the system and method of the present invention now follows.

The gift card manufacture server 18 may be implemented as either a dedicated computer server or a virtual server which runs as a resource on a computer of the gift card manufacturer. In particular, the gift card manufacturer server 18 provides ordering processing of gift card orders received from the merchant commerce server 14.

The merchant commerce server 14 may be implemented as either a dedicated computer server or virtual server which runs as a resource on a merchant's computer. In particular, the merchant commerce server 14 provides a storefront/transaction function 40, a communication function 42, a messaging function 44, and a key generation function 46 according to the present invention. These functions 40, 42, 44, and 46 are illustrated as software applications running on the merchant commerce server 14, and are created using standard Web development tools that may implemented them as dynamic Web applications. Such standard Web development tools include the HyperText Markup Language (HTML), Common Graphical Interface (CGI), object oriented programming languages, such as JAVA, ActiveX, C, C++ and the like.

The storefront/transaction function 40 performs a variety of tasks related to the purchasing of goods and services over the communications network 20. A customer accesses the storefront/transaction function 40 via a standard web browser 48 running on the customer communicative device 16. In general, the storefront/transaction function 40 permits the customer to view, choose, buy, and possibly use electronic objects. Preferably, the storefront/transaction function 40 is implemented on the merchant commerce server 14 similar to other conventional online electronic storefront application that provides product display, online ordering, and inventory management capabilities. Similar conventional storefront software includes Mercantec's SoftCart™, IBM's net.Commence, Microsoft's Commerce and the like. The present invention, like such conventional storefront software, works in conjunction with online funds verification servers 21, such as ICVerify, Verifone, eTill, First Virtual, Cybercash applications, which permit electronic money, credentials, and other tickets to be processed with networked bank servers as part of the payment approval process.

The communication function 42 manages communications between the merchant's commerce server 14, the customer communicative device 16, and other networked nodes, such as, and not limited to, the gift card manufacturer server 18, and the fund verification server 21 over the communications network 20. Additionally, the communication function 42 sets up and manages a secure transport medium between the merchant commerce server 14, the customer communicative device 16, and the gift card manufacturer server 18 when instructed by the transaction or electronic storefront application 40 with a conventional secure communication protocol such as HTTPS, SSL, PCT, SET, and the like.

The messaging function 44 routes messages among the merchant commerce server 14, the customer communicative device 16, the fund verification server 21, and the gift card manufacture server 18 for the processing of received gift card orders. Part of the messaging function 44, is acknowledging an order of the gift giver.

The key generation function 46 randomly generates a mathematically valid number or key 50. In addition, the key generation function 46 divides the key 50 into portions, and recombines received key portions for purposes that will be explained in later sections. It is to be appreciated that the key generation function 46 may be provide as an external/internal hardware module that is sold and implement with software implementing the methodology of the present invention. Such a hardware module may be provided as an interface card or peripheral connected directly to the bus of the merchant's server in a conventional fashion, or connected to the merchant's server via a secured network connection and provided as a service.

By mathematically valid number or key 50, it is meant any number that may be the result of any non-obvious algorithm, such as generated using cryptography, multi-digit modulus math, or seeded calculation, such that valid numbers cannot be logically predicted outside the system. Typically, the mathematically valid number or key 50 should be a very large number of base x which the key-generating function may convert to a smaller number by means of changing to a larger base y, where x<y. For example, the number 11733005289921 base 10 may be converted to 45q2geugx base 36. By converting a larger base x number to a smaller compact base y number, the pool of mathematically valid numbers is made both larger and more complex. Additionally, the conversion permits portions of the mathematically valid number or key 50 to be handled more conveniently by persons using the system, as will be explained hereafter with reference to FIGS. 1-4.

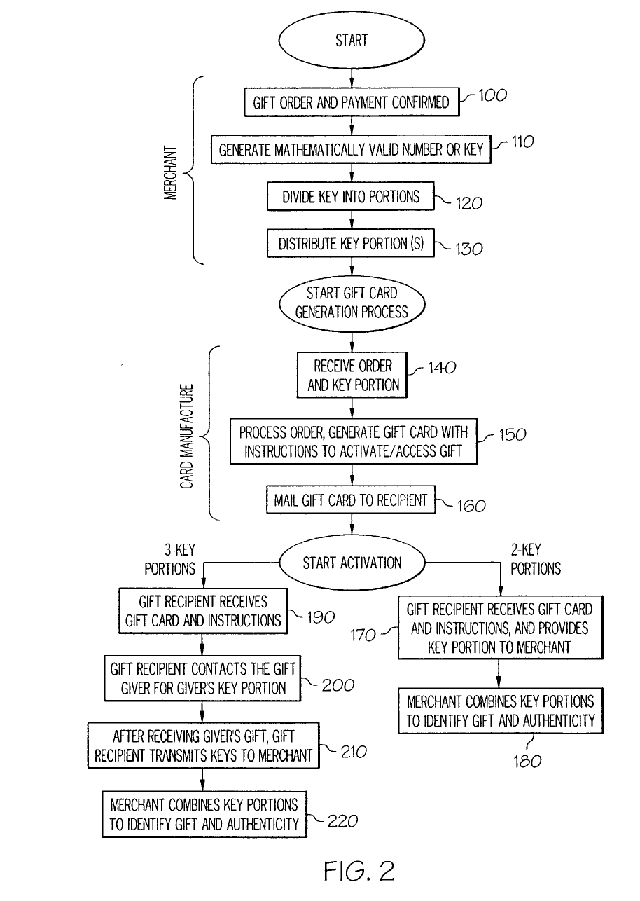

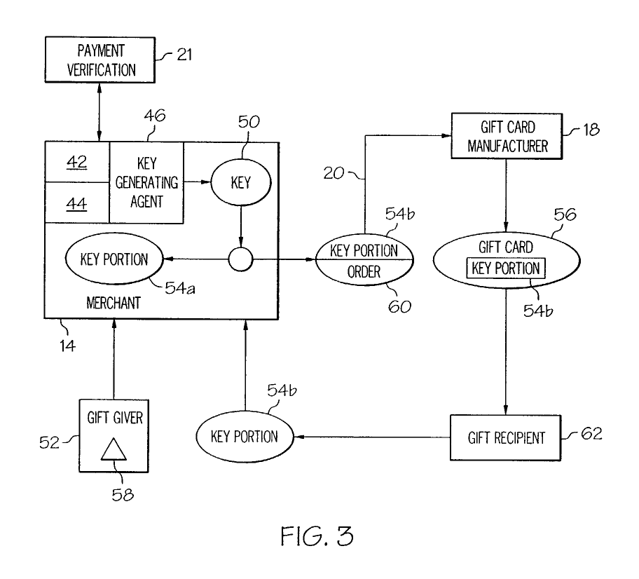

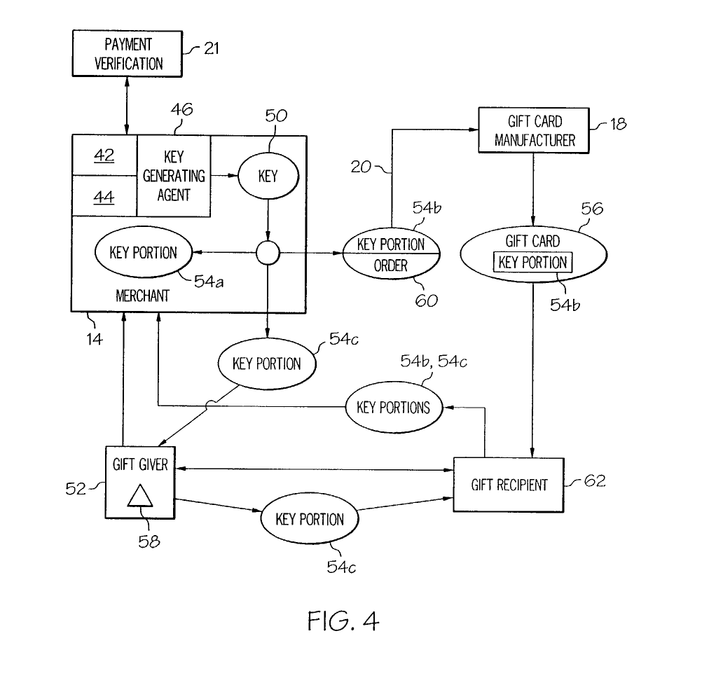

FIG. 2 is a flow chart diagram illustrating various secure gift-giving transactions according to the present invention implemented on the exemplary e-commerce system 12 in FIG. 1. A gift giver 52 places a gift order 58, such as for example, via the browser 48 over network 20 from the merchants server 14 as shown in FIG. 1. The relationship between internal and external processes of the secure gift-giving transactions is shown by FIGS. 3 and 4. After placing a gift order 58, and confirming payment by the funds verification server 21 (FIG. 1) in step 100, the key generation function 46 randomly generates a mathematically valid number or key 50 in step 110.

Next, the key-generating function 46 divides the key 50 into two or more key portions in step 120. In the embodiment illustrated in FIG. 3, the key 50 is divided into two key portions 54a and 54b. The first key portion 54a is stored on the merchant server 14, preferably in a secure database. The second key portion 54b is transmitted via network 20 to the gift card manufacturer 18 with gift order information 60 to be incorporated in the gift card 56.

In the embodiment illustrated in FIG. 4, the key 50 is divided into three key portions 54a, 54b, and 54c. Much like the previous embodiment illustrated by FIG. 3, the first key portion 54a is stored on the merchant server 14, preferably in a secure database. The second key portion 54b is transmitted to the gift card manufacturer server 18 with the gift order information 60 to be incorporated in the gift card 56, and a third key portion 54c is sent to the gift giver 52 as part of the acknowledgement for the gift order. Part of the acknowledgement is also included instructions that the gift recipient must be provided with the third key portion 54c in order to activate/redeem the gift.

After distributing the key portions 54a and 54b according to one of the above-described embodiments, the gift card generation process starts. After receiving the second key portion 54b and the gift card information 60 in step 140, the gift card manufacture server 18 initiates the internal process of the gift card manufacturer (not shown) to create the gift card 56. It is to be appreciated that the gift card manufacture server may be configured in any manner suitable to the gift card manufacturer's internal network and card-creation processes. Accordingly, such internal processes may be setup for on-demand processing (i.e., in-store kiosks) or for batch processing to generate a gift card 56 using the received gift card information 60 and incorporating therein at least the key portion 54b in step 150.

By the term “gift card,” it is meant a piece of material (paper, paperboard, plastic, and combinations thereof) which bears information, such as for example, a postcard, greeting card, birthday card, visiting card, debit card, and the like. Such a “gift card” may provide computer readable information stored therein, as in the form of magnetic encoding, bar coding, or electronic circuit components, which may be read by an external device.

The gift order information 60 includes the name, address, and phone number of the gift giver 52 and gift recipient 62, a description of the good and service purchased, a personalized message from the gift giver 53 to the gift recipient 62, a card type selection, merchant identifier codes, and a date. In step 160, the gift card 40 is then sent to the gift recipient 62 by traditional mail and/or electronic mail. In the discussion that follows, the gift recipient then redeems/activates the gift according to in one of the following methods.

If in step 130, the key 50 had been divided into two portions, the gift recipient 62 is then provided with instruction in the gift card 56 that to redeem/activate the gift, the enclosed key portion 54b need only be provided to the merchant server 14 as instructed. Accordingly, the gift recipient 62 provides the key portion 54b to the merchant server 14 in any conventional fashion (i.e., via a merchant, communicative device 16) in step 170. The key generation function 46 then validates the gift by recombining the two key portions 54a and 54b, thereby recreating the original key 50 in step 180. With the encrypted key 50 validated, the gift recipient 62 may then process with receiving the gift from the merchant.

If in step 130, the key 50 had been divided into three portions, the gift recipient 62 is then provided with instruction in the gift card 56 that to redeem/activate the gift, the gift recipient must contact the gift giver 52 to request the third key portion 54c in step 190. Upon receiving the third key portion 54c in step 200, the gift recipient 46 provides the second and third key portions 54b and 54c portion to the merchant server 14 in any conventional fashion (i.e., via a merchant, communicative device 16) in step 210. The key generation function 46 then validates the gift by recombining the three key portions 54a, 54b, and 54c, thereby recreating the original key 50 in step 220. With the key 50 validated, the gift recipient 62 may then process with receiving or activating the gift from the merchant.

It is to be appreciated that in any of the above embodiments that the key portions 54a, 54b, and 54c do not have to be equal, and it is in fact advantageous for some key-portions to be smaller than the others remaining portions. Additionally, it is to be appreciated that, if desired, the first key portion 54a may contain a copy of the original mathematically valid number or key 50. Furthermore, in such variation to the above described key distribution and authentication methods, the first key portion 54a may be the key, wherein combining the third and second portions combined and compared against the first key portion for authentication.

Moreover, it is to be appreciated that the gift card 56 may be an electronic gift card that may be sent to the gift recipient via an e-mail address. Finally, if desired, all transactions may be completely conducted via the communicative interface as described above and seen in FIG. 1, and/or by external/manual human interactions, such as the gift recipient physically going to a store of the merchant's to activate/redeem the gift card.

Although specific embodiments of, and examples for, the present invention have been described above for illustrative purposes, it is not intended that the invention be limited to these embodiments. Equivalent methods, structures, processes, steps, and other modifications within the spirit of the invention fall within the scope of the invention. For example, the teachings provided herein of the present invention can be applied to other client/server architectures, not necessarily the exemplary Internet based model described above. These and other changes may be made to the invention in light of the above detailed description. Accordingly, the invention is not limited by the disclosure, but instead the scope of the present invention is to be determined by the following claims.

What is claimed is:

1. A method of providing a secure gift-giving transaction via an electronic storefront of a merchant between a gift giver and a gift recipient, comprising:
receiving a gift order placed by the gift giver via the electronic storefront of the merchant;
generating at least first and second encrypted key portions;
transmitting gift order information containing said gift order and said second key portion to a gift provider;
sending said second key portion to the gift recipient;
receiving by said merchant from said gift recipient said second key portions, and
combining said key portions to fulfill said gift order.

2. The method of claim 1, further comprises acknowledging said gift order with a third key portion being sent to the gift giver, and said merchant receiving additionally said third key portion.

3. The method of claim 1, wherein said gift order is placed by the gift giver over a computer network via a communicative device.

4. The method of claim 3, wherein said communicative device is selected from the group consisting of kiosk, personal computer, personal digital assistant, web-phone, web-television, and other electronic-based platforms capable of providing the electronic storefront.

5. The method of claim 1, wherein the electronic storefront is hosted on a web server of the merchant.

6. The method of claim 1, wherein generating said first and second key portions is by using a cryptographic algorithm which generates a secure key which is then divided into said first and second key portions.

7. The method of claim 6, wherein said secure key is a number base x and said keys portions are base y where x<y.

8. The method of claim 1, wherein said gift order information comprises at least said gift order, a gift recipient address, and a gift card message.

9. The method of claim 1, further comprising receiving payment verification of the gift giver.

10. The method of claim 1, wherein transmitting said gift order information containing said gift order and said second key portion is carried out digitally over a computer network.

11. The method of claim 1, wherein said generating said first and second key portion is carried out on a merchant server.

12. The method of claim 10, wherein said transmitting is from a merchant server to a gift card manufacture server.

13. The method of claim 1, wherein said sending a gift card containing said at least said second key portion to the gift recipient is accomplished via a method selected from the group consisting of electronic mail, and postal mail.

14. The method of claim 1, wherein receiving said second key portion is carried out by said gift recipient providing said second key portion to a merchant server.

15. The method of claim 2, wherein receiving said second and third key portions is carried out by said gift recipient providing said second and third key portions to a merchant server.

16. A method of providing three-party authentication in a consumer gift-giving transaction between a gift giver and a gift recipient via a an electronic storefront of a merchant accessible over a computer network with a communicative device, comprising:
placing a gift order electronically from the electronic storefront;
receiving said gift order by a merchant server connected to the computer network,
generating at least first and second key encrypted portions upon said merchant server receiving payment verification of the gift giver;
transmitting gift order information containing at least said second key portion to a gift provider connected to the computer network;
sending said second key portion to the gift recipient; and
receiving by said merchant server said second key portions to fulfill said gift order.

17. The method of claim 16, further comprises acknowledging said gift order with a third key portion being sent to the gift giver, and said merchant receiving additionally said third key portion.

18. The method of claim 16, wherein said merchant server compares said first and second key portions to a key to fulfill said gift order.

19. The method of claim 17, wherein said merchant server compares said first, second, and third key portions to a key to fulfill said gift order.

20. A system adapted to provide a secure gift-giving transaction between a gift giver and a gift recipient from a merchant server adapted to provide an electronic storefront and to receive a gift order placed by the gift giver via a communicative device over a network, comprising:
a key generating function adapted to generate at least first and second encrypted key portions in response to the merchant server receiving the gift order, and to provide one of said key portions to the gift recipient.

21. The system of claim 20, wherein said at least first and second encrypted key portions further includes a third key portion, and said key generating function is further adapted to provide said third key portion to the gift giver.

22. The system of claim 20, wherein said key generating function is further adapted to recombine received key portions.

23. A system adapted to provide a secure gift-giving transaction between a gift giver and a gift recipient over a network via said gift giver using a communicative device, comprising:
a merchant server adapted to provide an electronic storefront and to receive a gift order placed by said gift giver via said communicative device over said network; and
a gift card manufacture server, wherein said merchant server is further adapted to generate at least first and second encrypted key portions, and to transmitting gift order information containing said gift order and said second key portion to said gift card manufacturer server.

24. The system of claim 23, wherein said at least first and second encrypted key portions further includes a third key portion, and said merchant server is further adapted to provide said third key portion to the gift giver.

25. The system of claim 23, wherein said merchant server is further adapted to recombine received key portions.
